(19) United States
(12) Patent Application Publication
(10) Pub. No.: US 2024/0418775 A1
(43) Pub. Date: Dec. 19, 2024

(54) METHOD AND SYSTEM FOR TRACKING AND MANAGING ACTIVITIES OF TESTBENCH COMPONENTS IN A TEST ENVIRONMENT

(71) Applicant: HCL America Inc., Sunnyvale, CA (US)

(72) Inventors: MANICKAM MUTHIAH, Shrewsbury, MA (US); KARTHIKEYAN KEELAPANDAL SUNDARAM, Chennai (IN); NISHA RAVICHANDRAN, Hudson, MA (US); SATHISH KUMAR KRISHNAMOORTHY, Madurai (IN); RAZI ABDUL RAHIM, Willowbrook, IL (US)

(21) Appl. No.: 18/209,544

(22) Filed: Jun. 14, 2023

(51) Int. Cl. G01R 31/3183; G01R 31/3185; G01R 31/319

(52) U.S. Cl. CPC G01R 31/318314; G01R 31/318569; G01R 31/31908

(57) ABSTRACT

A method for tracking and managing activities of testbench components in a test environment during a simulation is disclosed. In some embodiments, the method includes receiving a first Activity Tracking Unit (ATU) message from an ATU pre-installed within each of a plurality of testbench components. The method further includes registering each of the plurality of testbench components in response to receiving the first ATU message from the corresponding ATU. The method further includes selecting one or more configuration settings corresponding to the ATU of each of the plurality of testbench components based on one or more user requirements. The method further includes receiving at least one second ATU message from the corresponding ATU based on the one or more configuration settings, at an end of the simulation. The method further includes utilizing the at least one second ATU message to drive one or more outcomes corresponding to the simulation.

### TECHNICAL FIELD

Generally, the invention relates to pre-silicon functional simulation. More specifically, the invention relates to a method and system for tracking and managing activities of testbench components in a test environment during a simulation.

### BACKGROUND

Simulation testing allows designers to test functionality of a design before it is implemented in hardware. This process involves the use of a test environment (also called as testbench environment, verification environment etc.), which is a collection of software and hardware components that are used to simulate behavior of an electronic system. In order to analyze the system via simulation techniques, multiple simulation testbench components (for example, drivers, monitors, scoreboards, etc.) are used.

In a scenario, where a functional simulation of a Device Under Test (DUT) or System Under Test (SUT) present in the test environment with testbench components is in progress or complete, understanding the entire activity of each testbench component present in the test environment is time consuming. Moreover, in scenario, when the functional simulation is a long running simulation, then the amount of log files' information that needs to be reviewed might be huge. The log files information is reviewed to understand functionality of different testbench components present in the test environment during the functional simulation. Further, reviewing of these log files information to understand the functionality of each testbench component may be a time-consuming process. In addition, identification of any erroneous action or unexpected activity performed by any testbench component during the functional simulation may be a tedious task. Currently, there is no standard mechanism available to track activity of the testbench components present in the test environment and access associated log files information to understand functionality of each testbench component during progress of the functional simulation or after completion of the functional simulation.

Therefore, there is a need for implementing an efficient and reliable technique for tracking and managing activities of testbench components in the test environment during simulation.

### SUMMARY OF INVENTION

In one embodiment, a method for tracking and managing activities of testbench components in a test environment during a simulation is disclosed. The method may include receiving a first Activity Tracking Unit (ATU) message from an ATU pre-installed within each of a plurality of testbench components. It should be noted that, the first ATU message may include a unique Identity (ID) associated with each of the plurality of testbench components, an object handle to access the corresponding ATU, and an availability status of the corresponding ATU. The method may further include registering each of the plurality of testbench components in response to receiving the first ATU message from the corresponding ATU. It should be noted that, each of the plurality of testbench components may be registered based on the unique Identity (ID) associated with each of the plurality of testbench components and the object handle to access the corresponding ATU. The method may further include selecting one or more configuration settings corresponding to the ATU of each of the plurality of testbench components based on one or more user requirements. The method may further include receiving at least one second ATU message from the corresponding ATU based on the one or more configuration settings, at an end of the simulation. It should be noted that, the at least one second ATU message may include an output associated with a set of activities performed by each of the plurality of testbench components based on the one or more configuration settings. The method may further include utilizing the at least one second ATU message received from the ATU of each of the plurality of testbench components to drive one or more outcomes corresponding to the simulation.

In another embodiment, a system for tracking and managing activities of testbench components in a test environment during a simulation is disclosed. The system includes a processor and a memory communicatively coupled to the processor. The memory may store processor-executable instructions, which, on execution, may cause the processor to receive a first Activity Tracking Unit (ATU) message from an ATU pre-installed within each of a plurality of testbench components. It should be noted that, the first ATU message may include a unique Identity (ID) associated with each of the plurality of testbench components, an object handle to access the corresponding ATU, and an availability status of the corresponding ATU. The processor-executable instructions, on execution, may further cause the processor to register each of the plurality of testbench components in response to receiving the first ATU message from the corresponding ATU. It should be noted that, each of the plurality of testbench components may be registered based on the unique Identity (ID) associated with each of the plurality of testbench components and the object handle to access the corresponding ATU. The processor-executable instructions, on execution, may further cause the processor to select one or more configuration settings corresponding to the ATU of each of the plurality of testbench components based on one or more user requirements. The processor-executable instructions, on execution, may further cause the processor to receive at least one second ATU message from the corresponding ATU based on the one or more configuration settings, at an end of the simulation. It should be noted that, the at least one second ATU message may include an output associated with a set of activities performed by each of the plurality of testbench components based on the one or more configuration settings. The processor-executable instructions, on execution, may further cause the processor to utilize the at least one second ATU message received from the ATU of each of the plurality of testbench components to drive one or more outcomes corresponding to the simulation.

In yet another embodiment, a non-transitory computer-readable medium storing computer-executable instruction for tracking and managing activities of testbench components in a test environment during a simulation is disclosed. The stored instructions, when executed by a processor, may cause the processor to perform operations including receiving a first Activity Tracking Unit (ATU) message from an ATU pre-installed within each of a plurality of testbench components. It should be noted that, the first ATU message may include a unique Identity (ID) associated with each of the plurality of testbench components, an object handle to access the corresponding ATU, and an availability status of the corresponding ATU. The operations further include registering each of the plurality of testbench components in response to receiving the first ATU message from the corresponding ATU of each of the plurality of testbench components. It should be noted that, each of the plurality of testbench components may be registered based on the unique Identity (ID) associated with each of the plurality of testbench components and the object handle to access the corresponding ATU. The operations further include selecting one or more configuration settings corresponding to the ATU of each of the plurality of testbench components based on one or more user requirements. The operations further include receiving at least one second ATU message from the corresponding ATU based on the one or more configuration settings, at an end of the simulation. It should be noted that, the at least one second ATU message may include an output associated with a set of activities performed by each of the plurality of testbench components based on the one or more configuration settings. The operations further include utilizing the at least one second ATU message received from the ATU of each of the plurality of testbench components to drive one or more outcomes corresponding to the simulation.

It is to be understood that both the foregoing general description and the following detailed description are exemplary and explanatory only and are not restrictive of the invention, as claimed.

### BRIEF DESCRIPTION OF THE DRAWINGS

The present application can be best understood by reference to the following description taken in conjunction with the accompanying drawing figures, in which like parts may be referred to by like numerals.

FIG. 1 illustrates a functional diagram of a system for tracking and managing activities of testbench components in a test environment during a simulation, in accordance with an embodiment.

FIG. 2 illustrates exemplary formats of ATU messages received from a corresponding ATU pre-installed within each of a plurality of testbench components, in accordance with an embodiment.

FIG. 3 is a flowchart of a method for tracking and managing activities of testbench components in a test environment during a simulation, in accordance with an embodiment.

FIG. 4 is a flowchart of a method for receiving at least one second ATU message from a corresponding ATU, in accordance with an embodiment.

FIG. 5 is a flowchart of a method for rendering one or more outcomes derived from at least one second ATU message to a user, in accordance with an embodiment.

### DETAILED DESCRIPTION OF THE DRAWINGS

The following description is presented to enable a person of ordinary skill in the art to make and use the invention and is provided in the context of particular applications and their requirements. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the invention is not intended to be limited to the embodiments shown, but is to be accorded the widest scope consistent with the principles and features disclosed herein.

While the invention is described in terms of particular examples and illustrative figures, those of ordinary skill in the art will recognize that the invention is not limited to the examples or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on computer-readable storage media. Some other processes can be implemented using analog circuitry, as is well known to one of ordinary skill in the art. Additionally, memory or other storage, as well as communication components, may be employed in embodiments of the invention.

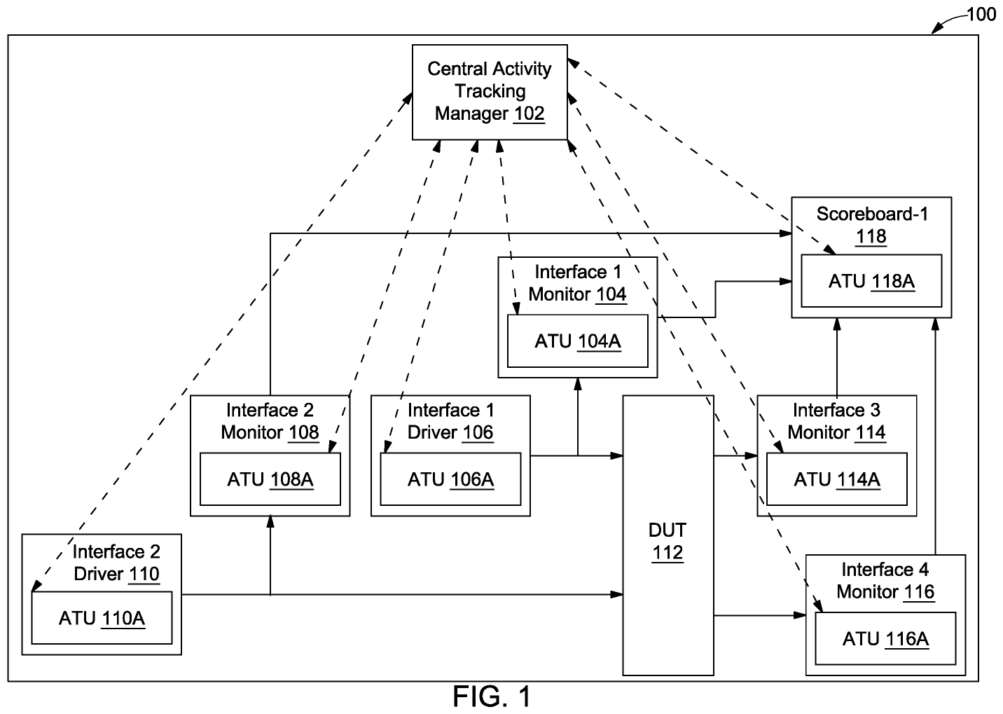

Referring now to FIG. 1, a functional block diagram of a system 100 for tracking and managing activities of testbench components in a test environment during a simulation is illustrated, in accordance with an embodiment. In order to track and manage activities of testbench components, the system 100 may include a central activity tracking manager 102. The central activity tracking manager may be configured to track and manage activities of a plurality of testbench components in the test environment. Examples of the plurality of testbench components may include, but is not limited to, an agent, sequencer, a driver, a monitor, a scoreboard, a checker, and a coverage collector.

For example, as shown in the present FIG. 1, the plurality of testbench components in an input and output interfaces of a DUT 112 may be represented as ‘Interface 1 Monitor 104’, ‘Interface 1 Driver 106’, ‘Interface 2 Monitor 108’, ‘Interface 2 Driver 110’, ‘scoreboard-1 118’, ‘Interface 3 Monitor 114’, and ‘Interface 4 Monitor 116’, respectively. Further, in order to track activities of the plurality of testbench components, each of the plurality of testbench components may include an activity tracking unit (ATU). The ATU may be pre-installed within each of the plurality of testbench components for tracking a set of activities corresponding to each of the plurality of testbench components.

In other words, the ATU may be pre-installed within each of the plurality of testbench components to track activities performed by each testbench component during the simulation. For example, the testbench component ‘Interface 1 Monitor 104’ may include an ATU 104A. The testbench component ‘Interface 1 Driver 106’ may include an ATU 106A. The testbench component ‘Interface 2 Monitor 108’ may include an ATU 108A. The testbench component ‘Interface 2 Driver 110’ may include an ATU 110A. The testbench component ‘scoreboard-1 118’ may include an ATU 118A. The testbench component ‘Interface 3 Monitor 114’ may include an ATU 114A. The testbench component ‘Interface 4 Monitor 116’ may include an ATU 116A.

In order to track and manage activities of each of the plurality of testbench components, initially, the central activity tracking manager 102 may be configured to receive a first ATU message from the ATU pre-installed within each of the plurality of testbench components. In an embodiment, the first ATU message may include a unique Identity (ID) associated with each of the plurality of testbench components, an object handle to access the corresponding ATU, and an availability status of the corresponding ATU. It should be noted that the user may install the ATU in one or more testbench components based on his requirement.

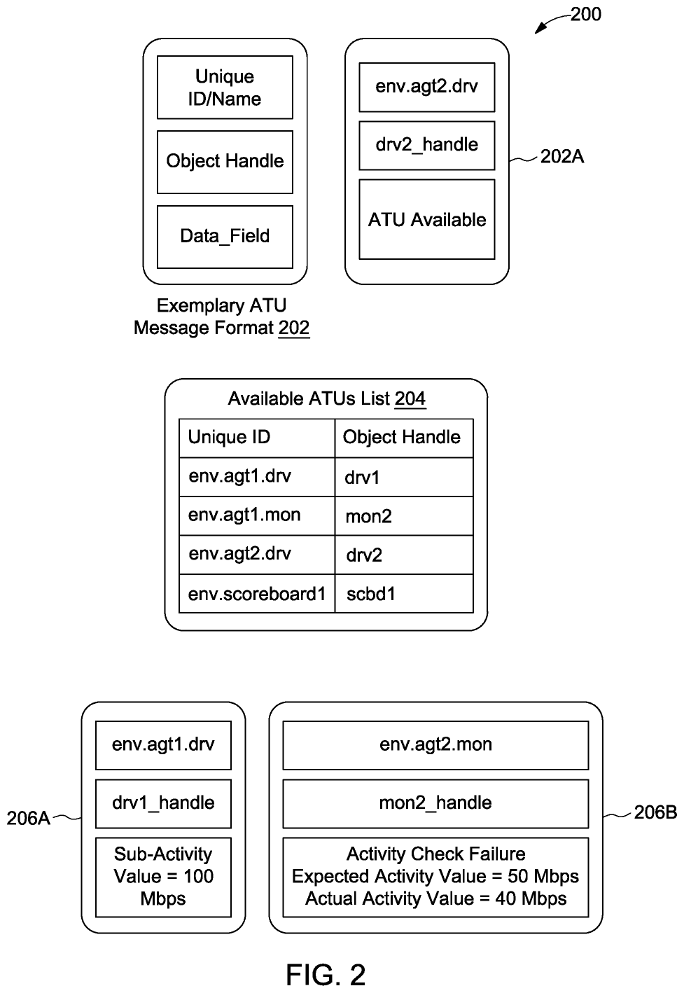

In response to receiving the first ATU message from the corresponding ATU, the central activity tracking manager 102 may register each of the plurality of testbench components. In an embodiment, each of the plurality of testbench components present in the test environment may be registered based on the unique ID associated with each of the plurality of testbench components and the object handle to access the corresponding ATU. As will be appreciated, the object handle may be an address of the ATU pre-installed within each of the plurality of testbench components. The address may be used for accessing the ATU of each of the plurality of testbench components. A format of the first ATU message that is to be received by the central activity tracking manager 102 via the corresponding ATU for registering each of the plurality of testbench components is depicted via FIG. 2.

Once each of the plurality of testbench components is registered, the central activity tracking manager 102 may select one or more configuration settings corresponding to the ATU of each of the plurality of testbench components based on one or more user requirements. The one or more configurations settings may be, for example, enabling or disabling the ATU of one or more testbench components, defining an expected activity value for one or more of a set of activities performed by the one or more testbench components, and enabling or disabling one or more activity checks corresponding to one or more of the set of activities performed by the one or more testbench components.

Further, based on the one or more configuration settings selected for the ATU of each of the plurality of testbench components, the central activity tracking manager 102 may receive at least one second ATU message from the corresponding ATU. The central activity tracking manager 102 may receive the at least one second ATU message from the corresponding ATU at an end of the simulation. In an embodiment, the at least one second ATU message may include an output associated with the set of activities performed by each of the plurality of testbench components based on the one or more configuration settings. The output associated with the set of activities may include a number of packets processed by each of the plurality of testbench components, content within each of the number of packets, sequence of processing each of the number of packets, idle cycles associated with the number of packets, the number of packets processing frequency of each of the plurality of testbench components, a status information of each of the plurality of testbench components, and start time and end time associated with processing of each of the number of packets. A format of the at least one second ATU message that is to be received by the central activity tracking manager 102 from the corresponding ATU at the end of simulation is depicted via FIG. 2.

Once the at least one second ATU message is received from the ATU of each of the plurality of testbench components, the central activity tracking manager 102 may further utilize the at least one second ATU message to drive one or more outcomes corresponding to the simulation. In an embodiment, the one or more outcomes derived from the at least one second ATU message may be used to perform at least one of: notifying an error associated with one or more of the plurality of testbench components, grading the simulation, and comparing at least two simulations for determining a difference in performance between the at least two simulation runs.

Further, the central activity tracking manager 102 may be configured to render the one or more outcomes derived from the at least one second ATU message received from the ATU of each of the plurality of testbench components to the user via a user interface (UI) of an electronic device. Examples of the electronic device may include, but is not limited to, a laptop, a tablet, a desktop, and a smartphone. The complete process of tracking and managing activities of testbench components in the test environment is further explained in greater detail in conjunction with FIGS. 2-5.

Referring now to FIG. 2, exemplary formats of ATU messages 200 received from a corresponding ATU pre-installed within each of a plurality of testbench components is illustrated, in accordance with an embodiment. FIG. 2 is explained with reference to FIG. 1. As mentioned in FIG. 1, in order to register each of the plurality of testbench components, the central activity tracking manager 102 may receive the first ATU message from the corresponding ATU at the start of the simulation. An exemplary ATU message format 202 is depicted via present FIG. 2. As depicted, the ATU message format 202 may include a unique ID associated with each of the plurality of testbench components (for example, a unique name or a hierarchical name of the testbench component), an object handle to access the corresponding ATU, and a Data_Field that carries a message. As will be appreciated, in an object-oriented programming language, the object handle may be an address with which the respective ATU may be accessed. In an embodiment, the ATU message format 202 may be applicable to the first ATU message 202A and the second ATU message 206A, and 206B.

An exemplary first ATU message 202A is depicted via the present FIG. 2. By way of an example, whenever the ATU of a testbench component sends the first ATU message 202A to the central activity tracking manager 102 in order to register the testbench component, the central activity tracking manager 102 may identify a source of the first ATU message 202A using the unique ID associated with that testbench component. For example, in order to register the testbench component ‘Interface 2 Driver 110’, the central activity tracking manger 102 may receive the first ATU message 202A from the ATU 110A of the testbench component ‘Interface 2 Driver 110’. Further as depicted via the present FIG. 2, the first ATU message 202A received by the central activity tracking manager 102 from the testbench component ‘Interface 2 Driver 110’ may include the unique ID of the testbench component ‘Interface 2 Driver 110’ in a format ‘env.agt2.drv’. In addition to the unique ID, the first ATU message 202A may include the object handle to access the ATU 110A, in a format ‘drv2_handle’. Further, in addition to the unique ID and the object handle, the first ATU message may include an ‘ATU Available’ message in the Data_Field. The ATU available message may be used to represent availability of the ATU 110A. In a similar way, other testbench components may also get registered with the central activity tracking manager 102.

Once each of the plurality of testbench components is registered, the central activity tracking manager 102 may store the received unique ID and the object handle associated with each of the plurality of testbench components in a form of a list called “Available ATUs List 204”, as depicted in present FIG. 2. Further, using the object handle of the corresponding ATU stored in the ‘Available ATUs List 204’, the central activity tracking manager 102 may select one or more configuration settings corresponding to the ATU of each of the plurality of testbench components. In an embodiment, the one or more configuration settings for the ATU may be selected based on one or more user requirements.

For example, the central activity tracking manager 102 may select one or more configuration settings to enable or disable the ATU of one or more testbench components from the plurality of testbench components, define an expected activity value for one or more of the set of activities performed by the one or more testbench components, and enable or disable one or more activity checks corresponding to one or more of the set of activities performed by the one or more testbench components.

Based on the one or more configuration settings, the central activity tracking manager 102 may further receive the at least one second ATU message from the corresponding ATU. It should be noted that the central activity tracking manager 102 may receive the at least one second ATU message at the end of the simulation. In other words, the at least one second ATU message may be sent by the corresponding ATU after performing one or more of the set of activities based on the one or more configuration settings selected for the corresponding ATU. An exemplary second ATU message 206A and 206B corresponding to two testbench components is depicted via the present FIG. 2.

With reference to FIG. 1, the two testbench components may correspond to ‘Interface 1 Driver 106’ and ‘Interface 2 Monitor 108’. Further, the ATU 106A of the ‘Interface 1 Driver 106’ and the ATU 108A of the ‘Interface 2 Monitor 108’ may send the second ATU message 206A and 206B, respectively, to the central activity tracking manager 102 at the end of the simulation. Further, the second ATU message 206A and 206B may include an output of a set of activities performed by the ‘Interface 1 Driver 106’ and the ‘Interface 2 Monitor 108’, respectively.

The output associated with the set of activities may include the number of packets processed by each of the plurality of testbench components, content within each of the number of packets, sequence of processing each of the number of packets, idle cycles associated with the number of packets, the number of packets processing frequency of each of the plurality of testbench components, the status information of each of the plurality of testbench components, and start time and end time associated with processing of each of the number of packets. In an embodiment, the output associated with the set of activities performed by a testbench component from the plurality of testbench components may correspond to at least one of: a consolidated output, and an evaluation output. The consolidated output may be referred to a sub-activity value that may be generated based on the set of activities performed by the testbench component (for example, average data rate, total number of clocks for which there is an activity). Further, the evaluation output may be referred to an expected activity value defined for an activity that is to be performed by the testbench component.

As depicted via the present FIG. 2, the second ATU message 206A received from the ATU 106A of the ‘Interface 1 Driver 106’ may include the unique ID, i.e., ‘env.agt1.drv’ of the ‘Interface 1 Driver 106’, the object handle, i.e., ‘drv1_handle’ of the ATU 106A installed in the ‘Interface 1 Driver 106’, and the output associated with the set of activities performed by the ‘Interface 1 Driver 106’. For example, the output generated by the ‘Interface 1 Driver 106’ may be the sub-activity value, i.e., ‘Sub-Activity Value=100 Mbps’, generated based on the set of activities performed by the ‘Interface 1 Driver 106’.

Similarly, the second ATU message 206B received from the ATU 108A of the ‘Interface 2 Monitor 108’ may include the unique ID, i.e., ‘env.agt2.mon’ of the ‘Interface 2 Monitor 108’, the object handle, i.e., ‘mon2_handle’ of the ATU 108A installed within the ‘Interface 2 Monitor 108’, and the output associated with the set of activities performed by the ‘Interface 2 Monitor 108’. By way of an example, as depicted via the second ATU message 206B, the output may be ‘Activity Check Failure, expected activity value=50 Mbps, actual activity value=40 Mbps’. It should be noted that, the central activity tracking manager 102 may take an expected activity value for a testbench component from the user and use it as a configuration setting for the respective testbench component (i.e. one of the configuration settings selected based on the first ATU message from the ATU of the respective testbench component) so that the testbench component may check if the actual activity value generated by it for the simulation matches with the expected activity value defined by the user.

In some embodiments, the corresponding ATUs (for example, the ATU 106A and the ATU 108A) may report the generated sub-activity value, the expected activity value, the actual activity value, and the activity check failure to the central activity tracking manager 102 through the second ATU message 206A and 206B, at the end of the simulation. The central activity tracking manager 102 may further utilize the at least one second ATU message received from the ATU of one or more of the plurality of testbench components to drive the one or more outcomes corresponding to the simulation.

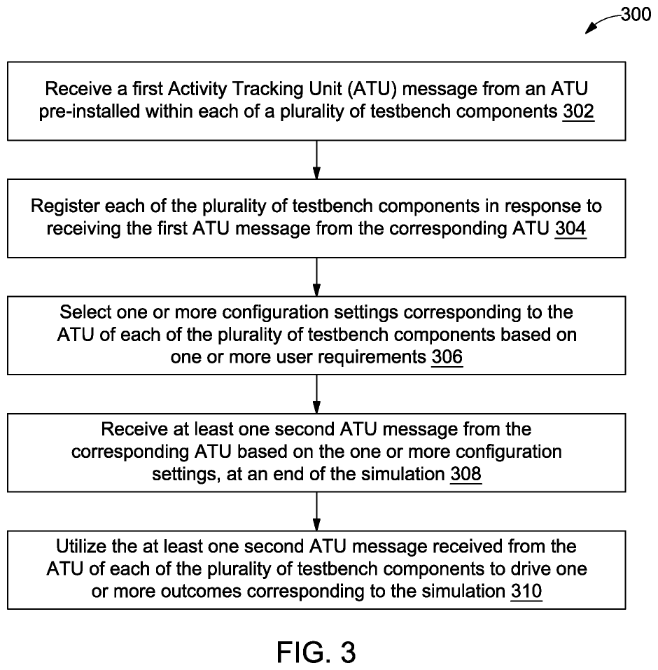

Referring now to FIG. 3, a flowchart of a method 300 for tracking and managing activities of testbench components in a test environment during a simulation is illustrated, in accordance with an embodiment. At step 302, a first ATU message may be received from an ATU pre-installed within each of a plurality of testbench components. In an embodiment, the first ATU message may include a unique Identity (ID) associated with each of the plurality of testbench components, an object handle to access the corresponding ATU, and an availability status of the corresponding ATU. Examples of the plurality of testbench components may include, but is not limited to an agent, sequencer, a driver, a monitor, a scoreboard, a checker, and a coverage collector.

Upon receiving the first ATU message (e.g., the first ATU message 202A) from the corresponding ATU, at step 304, each of the plurality of testbench components may be registered. In an embodiment, each of the plurality of testbench components may be registered based on the unique Identity (ID) associated with each of the plurality of testbench components and the object handle to access the corresponding ATU.

Once each of the plurality of testbench components is registered, at step 306, one or more configuration settings corresponding to the ATU of each of the plurality of testbench components may be selected. The one or more configuration settings corresponding to each of the plurality of testbench components may be selected based on one or more user requirements. In an embodiment, the one or more configurations settings may include enabling or disabling the ATU of one or more testbench components, defining an expected activity value for one or more of the set of activities performed by the one or more testbench components, and enabling or disabling one or more activity checks corresponding to one or more of the set of activities performed by the one or more testbench components.

Further, at step 308, at least one second ATU message may be received from the corresponding ATU based on the one or more configuration settings, at an end of the simulation. In an embodiment, the at least one second ATU message may include an output associated with a set of activities performed by each of the plurality of testbench components based on the one or more configuration settings. Further, the output generated based on the set of activities performed by each of the plurality of testbench components may be at least one of a consolidated output or an evaluation output. It should be noted that the consolidated output or the evaluation output corresponding to a testbench component may be generated based on the one or more configuration settings selected for the testbench component.

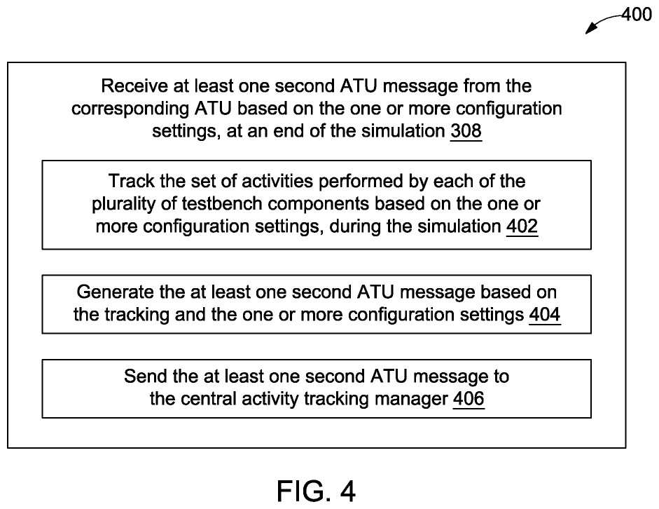

In an embodiment, the output associated with the set of activities may include the number of packets processed by each of the plurality of testbench components, content within each of the number of packets, sequence of processing each of the number of packets, idle cycles associated with the number of packets, the number of packets processing frequency of each of the plurality of testbench components, the status information of each of the plurality of testbench components, and start time and end time associated with processing of each of the number of packets. A method of receiving the at least one second ATU message is further explained in detail in reference to FIG. 4.

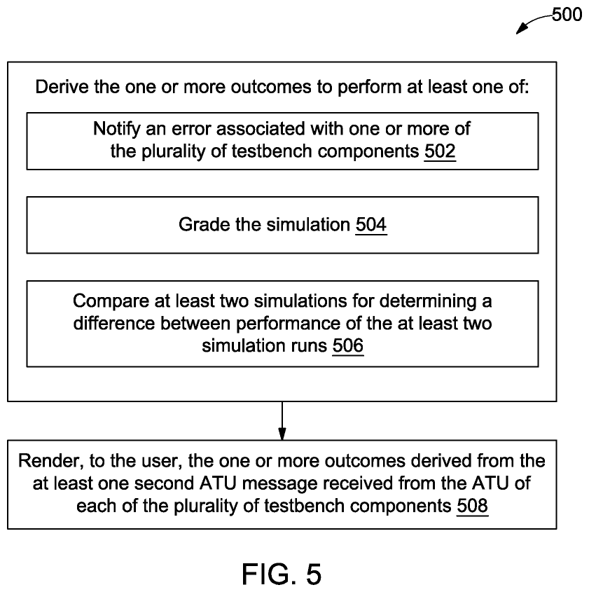

Further, at step 310, the at least one second ATU message received from the ATU of each of the plurality of testbench components may be utilized to drive one or more outcomes corresponding to the simulation. This is further explained in detail in conjunction with FIG. 5.

Referring now to FIG. 4, a flowchart of a method 400 for receiving at least one second ATU message from a corresponding ATU is illustrated, in accordance with an embodiment. The step 308 is already discussed in FIG. 2. To further elaborate, in order to receive the at least one second ATU message from the corresponding ATU, at step 402, the set of activities performed by each of the plurality of testbench components during the simulation, may be tracked by the corresponding ATU. In an embodiment, the corresponding ATU may track the set of activities of the testbench component based on the one or more configurations settings. With reference to FIG. 1, the one or more configuration settings may be selected by the user via the central activity tracking manager 102. The one or more configurations settings may include enabling or disabling the ATU of one or more testbench components, defining an expected activity value for one or more of the set of activities performed by the one or more testbench components, and enabling or disabling one or more activity checks corresponding to one or more of the set of activities performed by the one or more testbench components.

It should be noted that each of the ATU pre-installed within the plurality of testbench components may perform one or more checks based on the activity it tracks. By way of an example, the ATU pre-installed in one of a driver testbench component may identify if that driver testbench component from the plurality of testbench components is stuck or hung. In order to identify that the driver testbench component is stuck or hung, the ATU may keep tracking progress of the activity being performed by the driver testbench component. Further based on the tracking, when the ATU (e.g., the ATU 110A) does not detect any forward progress in the driver testbench component (for example, the ‘Interface 2 Driver 110’ waiting indefinitely for credits before it may drive a transaction into the DUT 112) for a specified period of time. In such condition, the corresponding ATU may report this issue to the central activity tracking manager 102 using the at least one second ATU message. Based on the at least second ATU message, the central activity tracking manager 102 may take an appropriate action (for example, terminating the simulation).

By way of another example, the ATU (e.g., the ATU 118A) pre-installed in a scoreboard (e.g., the ‘Scoreboard-1 118’) may keep tracking the scoreboard based on the one or more configuration settings selected. Further, based on the tracking, upon identifying that no checking has been performed by the scoreboard for the simulation until the end of the simulation, then the ATU of the scoreboard may further report this issue (i.e., no checking performed by the scoreboard for the simulation) to the central activity tracking manager 102 using the at least one second ATU message. The central activity tracking manager 102 may further report such issue to the user.

By way of another example, the ATU (e.g., the ATU 104A) pre-installed in one of a monitor (e.g., the ‘Interface 1 Monitor 104’) may be configured to check the monitor activity (referred as ‘Activity Check’) against an expectation (i.e., the expected activity value) at the end of the simulation. A result of the ‘Activity Check’ performed by the ATU of the monitor may be reported to the central activity tracking manager 102 using the at least one second ATU message. The central activity tracking manager 102 may collect the ‘Activity Check’ result from the corresponding ATU. Further, upon collecting the ‘Activity Check’ result for the ATU, the central activity tracking manager 102 may generate an Activity Check results summary (for user review) at the end of the simulation. It should be noted that, when the system 100 of a test environment is implemented (coded/developed), then the ATU may be implemented as a separate class (for example, class atu_component). The testbench component classes such as, driver, monitor classes, etc. may be derived (extended) from the atu_component class. For example, class abc_interface_driver extends atu_component, class abc_interface_monitor extends atu_component, and so on. This may enable easier implementation and consistency.

Further, at step 404, based on the tracking and the one or more configuration settings selected for the ATU of the testbench component, the ATU of each of the plurality of testbench components may generate the at least one second ATU message. The at least one second ATU message may include the output associated with the set of activities performed by each of the plurality of testbench components based on the one or more configuration settings. The output associated with the set of activities comprises the number of packets processed by each of the plurality of testbench components, content within each of the number of packets, sequence of processing each of the number of packets, idle cycles associated with the number of packets, the number of packets processing frequency of each of the plurality of testbench components, the status information of each of the plurality of testbench components, and start time and end time associated with processing of each of the number of packets.

Once the at least one second ATU message is generated, at step 406, the ATU of each of the plurality of testbench components may send the at least one second ATU message to the central activity tracking manager 102. In some embodiments, the central activity tracking manager 102 may utilize the at least one second ATU message received from the ATU of each of the plurality of testbench components to drive one or more outcomes corresponding to the simulation. Further, the one or more outcomes derived from the at least one second ATU message received from the corresponding ATU may be rendered to the user for user review. This is further explained in detail in reference to FIG. 5.

Referring now to FIG. 5, a flowchart of a method 500 for rendering one or more outcomes derived from at least one second ATU message to a user is illustrated, in accordance with an embodiment. At step 502, the one or more outcomes may be derived from the at least one second ATU message received from the ATU of each of the plurality of testbench components to notify an error associated with one or more of the plurality of testbench components. By way of an example, the central activity tracking manager 102 may notify the user when the simulation runs beyond a certain limit (in terms of simulation time or wall clock time) after it has detected that each of the plurality of testbench components that includes the ATU are idle (based on the at least one second ATU message with idle status information from the respective ATU). This notification may be useful as the user might not expect the simulation to run for an extended period after each of the plurality of testbench components are idle.

Further, at step 504 the one or more outcomes may be derived from the at least one second ATU message to grade the simulation. By way of an example, in reference to FIG. 1, the central activity tracking manager 102 may generate an activity value for each simulation based on the sub-activity value reported by the corresponding ATU of each of the plurality of testbench components present in the test environment. The central activity tracking manager 102 may further compute the activity value for the simulation by aggregating the sub-activity values reported by the corresponding ATUs. The activity value generated may be used for grading tests/simulations based on the activity in them.

Further, at step 506, the one or more outcomes may be derived from the at least one second ATU message to compare at least two simulations for determining a difference in performance between the at least two simulation runs. By way of an example, the central activity tracking manager 102 may collect activity check results from different ATUs and may provide an activity check results summary (for user review) at the end of the simulation. The central activity tracking manager 102 may further notify the user when there is a mismatch between an expected activity value (i.e., a result defined by the user for an activity to be performed by the testbench component) and an actual activity value (i.e., a result generated based on the activity performed by the testbench component) for one or more of the plurality of testbench components based on the activity check performed by the corresponding ATU installed in the plurality of testbench components.

In some embodiments, the central activity tracking manager 102 may generate a functional performance value for the simulation. The functional performance value may be generated by using the activity value for a simulation and a simulation time consumed for the simulation (i.e., the functional performance value=the activity value/the simulation time). The functional performance value generated as mentioned above may be a useful metric for comparing two different simulations. For example, the functional performance value generated for a simulation run on a specific design register-transfer level (RTL) version may be compared against the functional performance value generated for the same simulation run on a different version of the respective design RTL to identify or understand any functional performance difference between the at least two simulations (also referred as a simulation run). Once the one or more outcomes are derived from the at least one second ATU message as mentioned via the steps 502-506, the central activity tracking manager 102 may render the one or more derived outcomes to the user for the user review, at step 508.

Various embodiments provide a method and system for tracking and managing activities of testbench components in a test environment during a simulation. The disclosed method and system may receive a first Activity Tracking Unit (ATU) message from an ATU pre-installed within each of a plurality of testbench components. The first ATU message may include a unique Identity (ID) associated with each of the plurality of testbench components, an object handle to access the corresponding ATU, and an availability status of the corresponding ATU. Further, the disclosed method and system may register each of the plurality of testbench components in response to receiving the first ATU message from the corresponding ATU. It should be noted that, each of the plurality of testbench components may be registered based on the unique Identity (ID) associated with each of the plurality of testbench components and the object handle to access the corresponding ATU. Further, the disclosed method and system may select one or more configuration settings corresponding to the ATU of each of the plurality of testbench components based on one or more user requirements. Further, the disclosed method and system may receive at least one second ATU message from the corresponding ATU based on the one or more configuration settings, at an end of the simulation. The at least one second ATU message may include an output associated with a set of activities performed by each of the plurality of testbench components based on the one or more configuration settings. Thereafter, the disclosed method and system may utilize the at least one second ATU message received from the ATU of each of the plurality of testbench components to drive one or more outcomes corresponding to the simulation.

The disclosed method and system may provide some advantages like, the disclosed method and the system may be methodology independent and hence may be used across any of the existing industry standard verification methodologies. Further, the disclosed method and the system may track activities of a plurality of testbench components present in a test environment. In addition, the disclosed method and the system may install an ATU in each of the plurality of testbench components for tracking activities performed by each testbench component during the simulation. Moreover, the disclosed method and the system may render the one or more outcomes derived from the at least one second ATU message received from the ATU of each of the plurality of testbench components to the user for user review. The one or more outcomes derived from the at least one second ATU message may enable the user to quickly understand one or more activities performed by each testbench component during the simulation. In addition, the one or more outcomes may enable the user to perform simulation results analysis and understand reason for a simulation failure. This may improve an efficiency of the simulation results analysis and the simulation failures analysis as the ramp-up time required to understand the test environment/testbench components' activity for each simulation before doing the results/failure analysis may be cut down significantly with help of the disclosed method and system.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or process steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A method for tracking and managing activities of testbench components in a test environment during a simulation, the method comprising:
receiving, by a central activity tracking manager, a first Activity Tracking Unit (ATU) message from an ATU pre-installed within each of a plurality of testbench components, wherein the first ATU message comprises a unique Identity (ID) associated with each of the plurality of testbench components, an object handle to access the corresponding ATU, and an availability status of the corresponding ATU;
registering, by the central activity tracking manager, each of the plurality of testbench components in response to receiving the first ATU message from the corresponding ATU, wherein each of the plurality of testbench components is registered based on the unique Identity (ID) associated with each of the plurality of testbench components and the object handle to access the corresponding ATU;
selecting, by the central activity tracking manager, one or more configuration settings corresponding to the ATU of each of the plurality of testbench components based on one or more user requirements;
receiving, by the central activity tracking manager, at least one second ATU message from the corresponding ATU based on the one or more configuration settings, at an end of the simulation, wherein the at least one second ATU message comprises an output associated with a set of activities performed by each of the plurality of testbench components based on the one or more configuration settings; and
utilizing, by the central activity tracking manager, the at least one second ATU message received from the ATU of each of the plurality of testbench components to drive one or more outcomes corresponding to the simulation.

2. The method of claim 1, wherein the plurality of testbench components comprises an agent, sequencer, a driver, a monitor, a scoreboard, a checker, and a coverage collector.

3. The method of claim 1, wherein the one or more configurations settings comprises enabling or disabling the ATU of one or more testbench components, defining an expected activity value for one or more of the set of activities performed by the one or more testbench components, and enabling or disabling one or more activity checks corresponding to one or more of the set of activities performed by the one or more testbench components.

4. The method of claim 1, wherein receiving at least one second ATU message comprises:
tracking, by the corresponding ATU, the set of activities performed by each of the plurality of testbench components based on the one or more configuration settings, during the simulation;
generating, by the ATU of each of the plurality of testbench components, the at least one second ATU message based on the tracking and the one or more configuration settings; and
sending, by the ATU of each of the plurality of testbench components, the at least one second ATU message to the central activity tracking manager.

5. The method of claim 1, wherein the output associated with the set of activities comprises a number of packets processed by each of the plurality of testbench components, content within each of the number of packets, sequence of processing each of the number of packets, idle cycles associated with the number of packets, the number of packets processing frequency of each of the plurality of testbench components, a status information of each of the plurality of testbench components, and start time and end time associated with processing of each of the number of packets.

6. The method of claim 1, wherein the output associated with the set of activities performed by a testbench component from the plurality of testbench components corresponds to at least one of: a consolidated output, and an evaluation output.

7. The method of claim 1, further comprising:
rendering, to the user, the one or more outcomes derived from the at least one second ATU message received from the ATU of each of the plurality of testbench components.

8. The method of claim 7, wherein the one or more outcomes derived from the at least one second ATU message is used for performing at least one of:
notifying an error associated with one or more of the plurality of testbench components;
grading the simulation; and
comparing at least two simulations for determining a difference in performance between the at least two simulation runs.

9. A system for tracking and managing activities of testbench components in a test environment during a simulation, the system comprising:
a processor; and
a memory coupled to the processor, wherein the memory stores processor-executable instructions, which, on execution, causes the processor to:
receive a first Activity Tracking Unit (ATU) message from an ATU pre-installed within each of a plurality of testbench components, wherein the first ATU message comprises a unique Identity (ID) associated with each of the plurality of testbench components, an object handle to access the corresponding ATU, and an availability status of the corresponding ATU;
register each of the plurality of testbench components in response to receiving the first ATU message from the corresponding ATU, wherein each of the plurality of testbench components is registered based on the unique Identity (ID) associated with each of the plurality of testbench components and the object handle to access the corresponding ATU;
select one or more configuration settings corresponding to the ATU of each of the plurality of testbench components based on one or more user requirements;
receive at least one second ATU message from the corresponding ATU based on the one or more configuration settings, at an end of the simulation, wherein the at least one second ATU message comprises an output associated with a set of activities performed by each of the plurality of testbench components based on the one or more configuration settings; and
utilize the at least one second ATU message received from the ATU of each of the plurality of testbench components to drive one or more outcomes corresponding to the simulation.

10. The system of claim 9, wherein the plurality of testbench components comprises an agent, sequencer, a driver, a monitor, a scoreboard, a checker, and a coverage collector.

11. The system of claim 9, wherein the one or more configurations settings comprises enabling or disabling the ATU of one or more testbench components, defining an expected activity value for one or more of the set of activities performed by the one or more testbench components, and enabling or disabling one or more activity checks corresponding to one or more of the set of activities performed by the one or more testbench components.

12. The system of claim 9, wherein, to receive the at least one second ATU message, the processor-executable instructions further cause the processor to:
track, by the corresponding ATU, the set of activities performed by each of the plurality of testbench components based on the one or more configuration settings, during the simulation;
generate, by the ATU of each of the plurality of testbench components, the at least one second ATU message based on the tracking and the one or more configuration settings; and
send, by the ATU of each of the plurality of testbench components, the at least one second ATU message to the central activity tracking manager.

13. The system of claim 9, wherein the set of activities comprises a number of packets processed by each of the plurality of testbench components, content within each of the number of packets, sequence of processing each of the number of packets, idle cycles associated with the number of packets, the number of packets processing frequency of each of the plurality of testbench components, a status information of each of the plurality of testbench components, and start time and end time associated with processing of each of the number of packets.

14. The system of claim 9, wherein the output generated based on the set of activities performed by a testbench component from the plurality of testbench components corresponds to at least one of: a consolidated output, and an evaluation output.

15. The system of claim 9, wherein the processor-executable instructions further cause the processor to:
render, to the user, the one or more outcomes derived from the at least one second ATU message received from the ATU of each of the plurality of testbench components.

16. The system of claim 15, wherein the one or more outcomes derived from the at least one second ATU message is used to perform at least one of:
notifying an error associated with one or more of the plurality of testbench components;
grading the simulation; and
comparing at least two simulations for determining a difference between performance of the at least two simulation runs.

17. A non-transitory computer-readable storage medium having stored thereon, a set of computer-executable instructions causing a computer comprising one or more processors to perform steps comprising:
receiving a first Activity Tracking Unit (ATU) message from an ATU pre-installed within each of a plurality of testbench components, wherein the first ATU message comprises a unique Identity (ID) associated with each of the plurality of testbench components, an object handle to access the corresponding ATU, and an availability status of the corresponding ATU;
registering each of the plurality of testbench components in response to receiving the first ATU message from the corresponding ATU, wherein each of the plurality of testbench components is registered based on the unique Identity (ID) associated with each of the plurality of testbench components and the object handle to access the corresponding ATU;
selecting one or more configuration settings corresponding to the ATU of each of the plurality of testbench components based on one or more user requirements;
receiving at least one second ATU message from the corresponding ATU based on the one or more configuration settings, at an end of the simulation, wherein the at least one second ATU message comprises an output associated with a set of activities performed by each of the plurality of testbench components based on the one or more configuration settings; and
utilizing the at least one second ATU message received from the ATU of each of the plurality of testbench components to drive one or more outcomes corresponding to the simulation.
